(19) United States
(12) Patent Application Publication
(10) Pub. No.: US 2014/0195594 A1
(43) Pub. Date: Jul. 10, 2014

(54) METHOD AND SYSTEM FOR DISTRIBUTED PROCESSING, RENDERING, AND DISPLAYING OF CONTENT

(71) Applicant: NVIDIA Corporation, Santa Clara, CA (US)

(72) Inventors: Alok AHUJA, San Jose, CA (US); Aleksandar ODOROVIC, Santa Clara, CA (US); Andrija BOSNJAKOVIC, Santa Clara, CA (US)

(73) Assignee: NVIDIA Corporation, Santa Clara, CA (US)

(21) Appl. No.: 14/054,728

(22) Filed: Oct. 15, 2013

Related U.S. Application Data
(60) Provisional application No. 61/749,231, filed on Jan. 4, 2013.
(60) Provisional application No. 61/749,224, filed on Jan. 4, 2013.
(60) Provisional application No. 61/749,233, filed on Jan. 4, 2013.

(51) Int. Cl. H04L 29/06

(52) U.S. Cl. CPC H04L 65/60
USPC 709/203

(57) ABSTRACT

A system and method for distributed processing, rendering, and displaying of content. A first client request is received from a first client of a plurality of clients. The first client request is authenticated from the first client of the plurality of clients. A first data stream type is determined, based on the first client request, to establish with the first client of the plurality of clients. The first session comprising the first data type is established, based on a determination of the first data stream type, with the first client of the plurality of clients. The data of the first stream data type is provided for the first session to the first client of the plurality of clients.

### CROSS-REFERENCE TO RELATED APPLICATIONS

This application claims priority from U.S. Provisional Application No. 61/749,231, “HANDHELD GAMING CONSOLE,” Attorney Docket NVID P-SC-12-0470-USO, filed Jan. 4, 2013, the entire disclosure of which is incorporated herein by reference. This application claims priority from U.S. Provisional Application No. 61/749,224, “NETWORK-ATTACHED GPU DEVICE,” Attorney Docket NVID P-SC-12-0814-USO, filed Jan. 4, 2013, the entire disclosure of which is incorporated herein by reference. This application claims priority from U.S. Provisional Application No. 61/749,233, “STREAMING FOR PORTABLE GAMING DEVICE,” Attorney Docket NVID P-SC-12-0862-USO, filed Jan. 4, 2013, the entire disclosure of which is incorporated herein by reference.

### BACKGROUND OF THE INVENTION

Historically, an application such as a video game was executed (played) using a personal computer (PC) or using a console attached to a television. A user purchased or rented a game, which was loaded onto the PC or inserted into the game console and then played in a well-known manner.

More recently, streaming has become a well-known method of accessing online content. Streaming or media streaming is a technique for sending data continuously while a receiver processes the data continuously. Streaming technologies are becoming increasingly important with the growth of cloud gaming. The proper combination of streaming media and video games may allow users to take advantage of streaming technologies to innovate more convenient and efficient methods of execution.

### BRIEF SUMMARY OF THE INVENTION

Accordingly, one or more embodiments of the invention are directed to methods and systems for distributed processing, rendering, and displaying of content.

In one or more embodiments, a system includes a server executing on a computer processor configured to receive a first client request from a first client of a plurality of clients. The system includes authenticating the first client request from the first client of the plurality of clients. The system also includes determining a first data stream type, based on the first client request, to establish with the first client of the plurality of clients. The system further includes establishing the first session comprising the first data type, based on the determination of the first data stream type, with the first client of the plurality of clients. The system additionally includes providing the data of the first stream data type for the first session to the first client of the plurality of clients.

In one or more embodiments, a method includes receiving a first client request from a first client of a plurality of clients. The method includes authenticating the first client request from the first client of the plurality of clients. The method also includes determining a first data stream type, based on the first client request, to establish with the first client of the plurality of clients. The method further includes establishing the first session comprising the first data type, based on the determination of the first data stream type, with the first client of the plurality of clients. The method additionally includes providing the data of the first stream data type for the first session to the first client of the plurality of clients.

In one or more embodiments, a non-transitory computer readable medium comprising a plurality of instructions configured to execute on at least one computer processor to enable the computer processor to receive a first client request from a first client of a plurality of clients. The non-transitory computer readable medium includes authenticating the first client request from the first client of the plurality of clients. The non-transitory computer readable medium also includes determining a first data stream type, based on the first client request, to establish with the first client of the plurality of clients. The non-transitory computer readable medium further includes establishing the first session comprising the first data type, based on the determination of the first data stream type, with the first client of the plurality of clients. The non-transitory computer readable medium additionally includes providing the data of the first stream data type for the first session to the first client of the plurality of clients.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computer system capable of implementing embodiments according to the present invention.

FIG. 2 is a block diagram of an example of a client device capable of implementing embodiments according to the present invention.

FIG. 3 is a block diagram of an example of a network architecture in which client systems and servers may be coupled to a network, according to embodiments of the present invention.

FIG. 4 is a block diagram of an exemplary data stream distribution device, according to embodiments of the present invention.

FIG. 5 is a block diagram of a one-to-many connection of a server distributing content to a plurality of clients corresponding to a plurality of devices, according to embodiments of the present invention.

FIG. 6A shows an example of a server and a client communicating different data stream types, according to embodiments of the present invention.

FIG. 6B shows an example of a server providing different data stream types to a plurality of clients, according to embodiments of the present invention.

FIG. 7A is a block diagram of a display, an audio player, and a controller connected to a locally-based server via network, according to embodiments of the present invention.

FIG. 7B is a block diagram of a display, an audio player, and a controller communicatively coupled with a locally-based server, according to embodiments of the present invention.

FIG. 8 is a block diagram of a display, an audio player, and a controller communicatively coupled with a cloud-based server, according to embodiments of the present invention.

FIG. 9 is a block diagram of a display, an audio player, and a controller communicatively coupled with the cloud-based server that is in turn communicatively coupled with a set-top box (STB), according to embodiments of the present invention.

FIG. 10 is a block diagram of a display, an audio player, and a controller communicatively coupled with an app store, locally-based server, cloud-based server, STB, according to embodiments of the present invention.

FIG. 11 depicts a flowchart of an exemplary computer-implemented process of distributing data stream type data according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

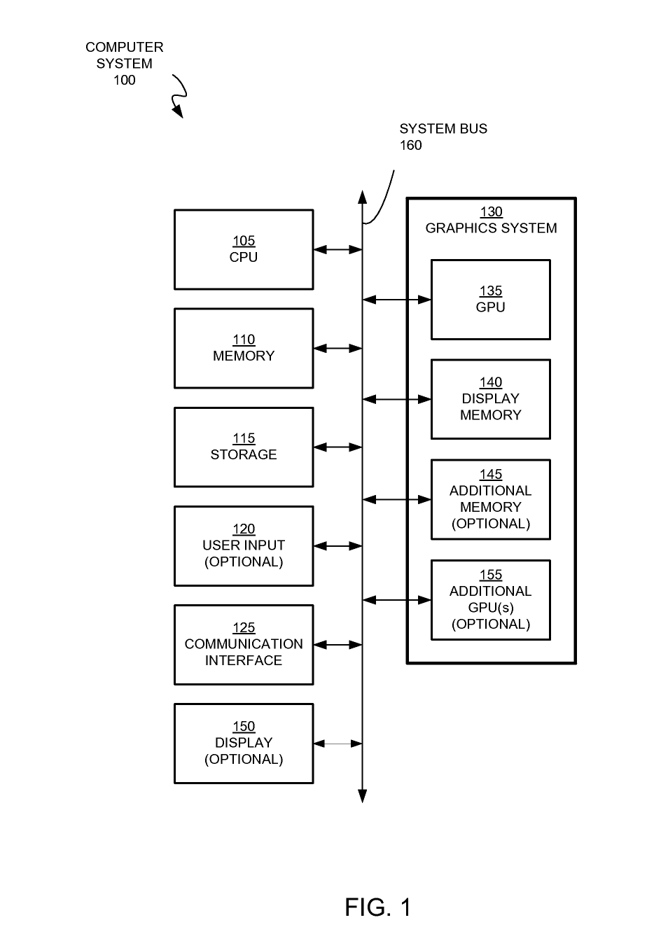

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more system buses 160 (system buses 160 may be or may include data buses, control buses, address buses, and/or any other internal buses).

In the embodiment of FIG. 1, a graphics system 130 may be coupled with the system bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a frame buffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the system bus 160, or each additional GPU 155 can be located on another circuit board separately coupled with the system bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

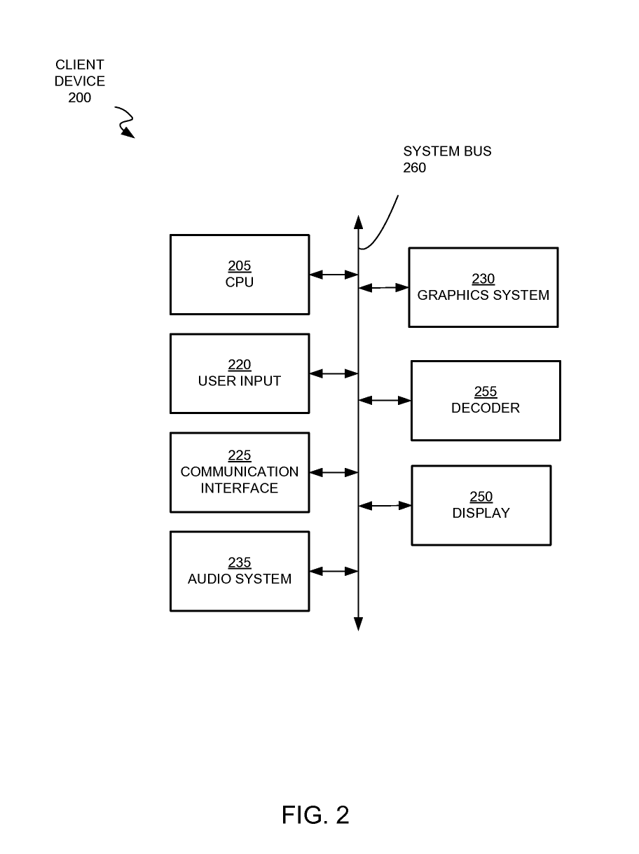

FIG. 2 is a block diagram of an example of a client device 200 capable of implementing embodiments according to the present invention. In the example of FIG. 2, the client device 200 includes a CPU 205 for running software applications and optionally an operating system. The user input 220 includes devices that communicate user inputs from one or more users and may include keyboards, mice, joysticks, touch screens, cameras, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) data that may be encoded (compressed). For example, the decoder 255 may be an H.264 decoder. The display device 250 may be any device capable of displaying visual information, including information received from the decoder 255. In another example, the decoder 255 may be an MP3 decoder. The audio system 235 may be any device capable of reproducing audible information, including information received from the decoder 255. The display device 250 may be used to display visual information generated at least in part by the client device 200. However, the display device 250 may be used to display visual information received from the computer system 100. The components of the client device 200 may be coupled via one or more system buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. However, the client device 200 may include other components including all those described above with regard to the computer system 100, for example, graphics system 230 that may be similar to graphics system 130 of FIG. 1. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, a hand-held gaming system, or the like.

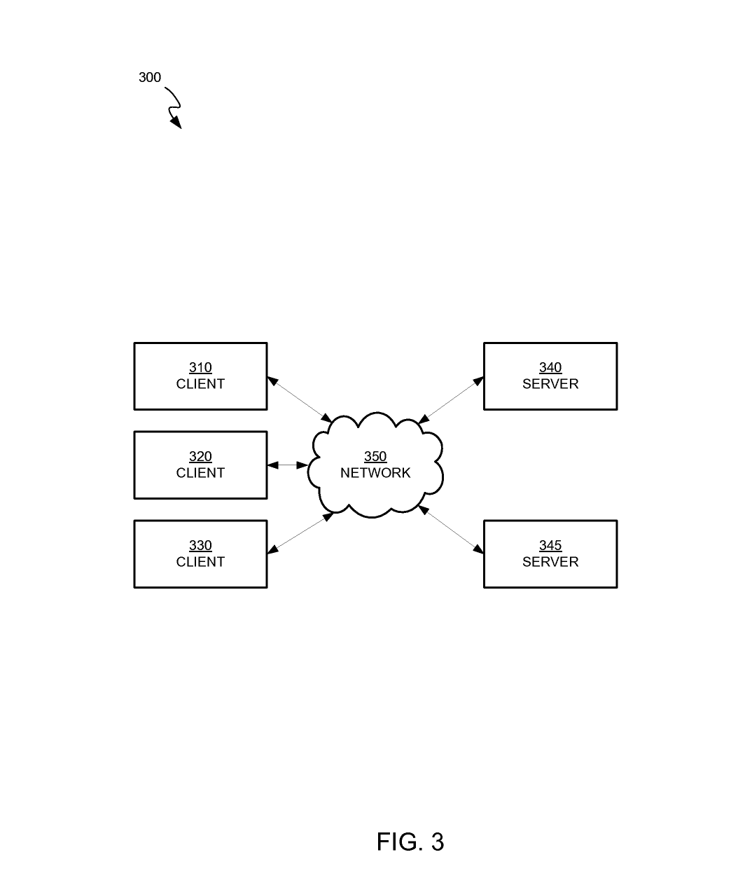

FIG. 3 is a block diagram of an example of a network architecture 300 in which client systems 310, 320, and 330 and servers 340 and 345 may be coupled to a network 350. Client systems 310, 320, and 330 generally represent any type or form of computing device or system, such as computer system 100 of FIG. 1 or client device 200 of FIG. 2.

Similarly, servers 340 and 345 generally represent computing devices or systems, such as application servers, configured to provide various services and/or run certain software applications. Network 350 generally represents any telecommunication or computer network including, for example, an intranet, a wide area network (WAN), a local area network (LAN), a personal area network (PAN), or the Internet.

With reference to computer system 100 of FIG. 1, a communication interface, such as communication interface 125, may be used to provide connectivity between each client system 310, 320, and 330 and network 350. Client systems 310, 320, and 330 may be able to access information on server 340 or 345 using, for example, a Web browser or other client software. Such software may allow client systems 310, 320, and 330 to access data hosted by server 340 and server 345. Although FIG. 3 depicts the use of a network (such as the Internet) for exchanging data, the embodiments described herein are not limited to the Internet or any particular network-based environment.

All or a portion of one or more of the example embodiments disclosed herein may also be encoded as a computer program, stored in server 340, run by server 345, and distributed to client systems 310, 320, and 330 over network 350. In one embodiment, all or a portion of one or more of the example embodiments disclosed herein are encoded as a computer program and loaded onto and executed by server 340 and server 345.

Method and System for Distributed Processing, Rendering, and Displaying of Content

Embodiments of the present invention provide methods and systems for distributed processing, rendering, and displaying of content, for example, the distribution of gaming content. However, embodiments of the present invention can be applied to distributing data of any type of content to a plurality of clients.

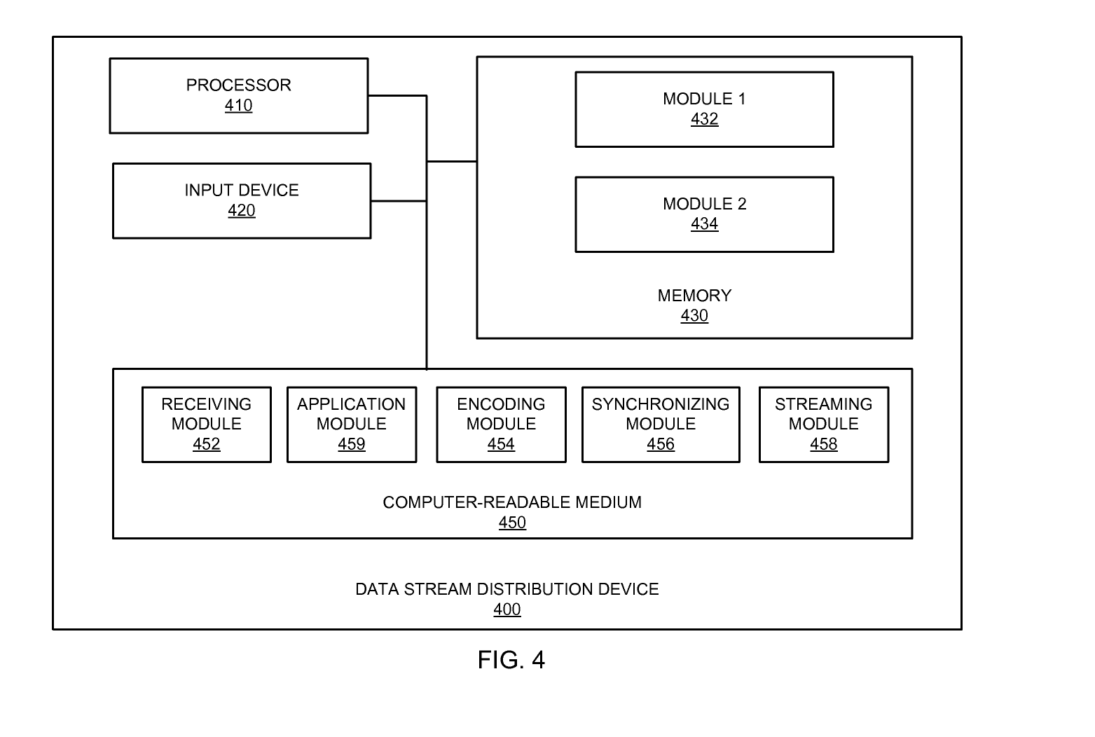

FIG. 4 is a block diagram of a data stream distribution device 400, according to embodiments of the present invention. Data stream distribution device 400 includes a processor 410, input device 420, memory 430, and computer-readable medium 450.

In one or more embodiments, a processor 410 may be any general-purpose processor operable to carry out instructions on the data stream distribution device 400. The processor 410 is coupled to other units of the data stream distribution device 400 including input device 420, memory 430, and computer-readable medium 450.

In one or more embodiments, an input device 420 may be any device that accepts input from a user. Examples may include a keyboard, keypad, mouse, speakers, microphones, controllers etc. In one or more embodiments, a multi-touch pad may be an input device. In one or more embodiments, input device may be virtual hardware that simulates behavior of actual input hardware device.

In one or more embodiments, memory 430 may be any magnetic, electronic, or optical memory. The memory 430 may include two memory modules, module 1 432 and module 2 434. It can be appreciated that memory 430 may include any number of memory modules. An example of memory 430 may be dynamic random access memory (DRAM).

In one or more embodiments, a computer-readable medium 450 may be any magnetic, electronic, optical, or other computer-readable storage medium. The computer-readable storage medium 450 includes receiving module 452, encoding module 454, synchronizing module 456, streaming module 458, and application module 459. The computer-readable storage medium 450 may comprise any combination of volatile and/or non-volatile memory such as, for example, buffer memory, RAM, DRAM, ROM, flash, or any other suitable memory device, alone or in combination with other data storage devices.

In one or more embodiments, a receiving module 452 may be configured to receive data through a network from a plurality of clients. In one or more embodiments, the receiving module includes functionality to receive one or more client requests through a network from a plurality of client devices. The client request may be a request from a client that may include data identifying the computing device of the client (e.g., a controller, headphones, or a display etc.). In one or more embodiments, the receiving module 452 may determine the computing device of the client based on the client request. For example, the client request may include data identifying the origin of the client request and the computing device of the client.

In one or more embodiments, the network may be the network 350 of FIG. 3. In one or more embodiments, the plurality of clients may be a plurality of handheld gaming devices. For example, receiving module 452 may receive a client request for gaming content from a plurality of handheld gaming devices. The client request for gaming content may include requesting video data, audio data, and output data of the game. The client request may be received by the receiving module via wireless or wired standard, e.g., Wi-Fi or Ethernet.

In one or more embodiments, the client request may include a vector indicating the type of content requested for the computing device of the client. The vector may include one or more parameters (e.g., an instruction set or a set of instructions) identifying the type of content requested. Further, the vector may identify a location of data stored in a server (e.g., data repository) based on the parameters of the vector. In addition, a single vector may include an instruction containing multiple sets of data. For example, the receiving module 452 may receive a client request including a vector requesting video content of a multiplayer game that indicates the specific game, a portion of content from the game, and the format of the video content. In one or more embodiments, multiple vectors may be included with a client request.

In one or more embodiments, the receiving module 452 includes functionality to authenticate the client request according to one or more criteria. For example, the one or more criteria may include evaluating the client request based on a client identifier, in the client request, associated with each client. The receiving module 452 may validate the device requesting content based on the client identifier. In another example, the receiving module 452 may require the client to access an internal network using a login and password prior to authorizing the client request.

In one or more embodiments, the receiving module 452 uses the client identifier of the client request to identify the computing device of the client. For example, the receiving module 452 may identify the client, using the client identifier, as a wireless handheld gaming controller. Accordingly, the type of computing device may be sufficient to determine the type of content requested by the client. In one or more embodiments, the receiving module 452 may indicate the appropriate content for the computing device identified from the client identifier. For example, the receiving module may determine that a wireless handheld gaming device requires input and output data.

In one or more embodiments, an encoding module 454 may be configured to encode the received content from the plurality of client devices. In one or more embodiments, the content received by receiving module 452 may be in an encoded format, e.g., H.264. The encoding module 454 may encode the received content into a format suitable for decoding by a client device. For example, the received content may include input commands received by a wireless game controller and encoded into graphical images for display on the attached display device.

In one or more embodiments, a synchronizing module 456 may be configured to synchronize content received from the plurality of devices into a single session, e.g. a combined or common session. For example, the single session may include data stream types between a server and a client synchronized to generate an online multiplayer game. The synchronizing module 456 may synchronize the received and decoded content from a plurality of devices to be rendered and processed for display on an attached display device (not shown). The rendering and processing may be synchronized based at least in part on the number of devices. For example, if receiving module 452 receives client requests for video content from two separate devices, the synchronizing module 456 may synchronize the streaming of the video content for the two devices into a single session. Similarly, the synchronizing module 456 may merge and synchronize other types of content from one of the devices into an existing single session. The synchronizing module 456 may then, upon synchronization, combine the content into a single session.

In one or more embodiments, a streaming module 458 is configured to provide data to the plurality of clients in response to a client request from a client. The streaming module 458 may provide one or more data stream types (e.g., video, audio, etc.). The streaming module 458 may include functionality for retrieving and providing data stored in a data repository or a server. In one or more embodiments, the streaming module may communicate with other modules of the data distribution device 400.

In one or more embodiments, the streaming module 458 includes functionality to establish a session between a server and a client based on a client request received by the receiving module 452. The session may include types of content corresponding to data stream type determined by the receiving module 452. For example, a session may be established for video content of a multiplayer game between the server and the client. In addition, the streaming module 458 further includes functionality to provide multiple sessions for a plurality of clients, in accordance with one or more embodiments. In one or more embodiments, the session may include one or more data stream types per client according to the client request. For example, a session may be a game session including audio, video, and input content streaming to one or more game devices.

In one or more embodiments, the streaming module 458 may include rendering and processing content based on instructions decoded by the decoding module 454. In one or more embodiments, the streaming module 458 includes functionality to render and process graphics on a GPU 135 (e.g., general purpose processing, displaying rendered graphics, encoding rendered graphics, etc.). The rendering and processing functionality of the streaming module may be expanded into additional modules.

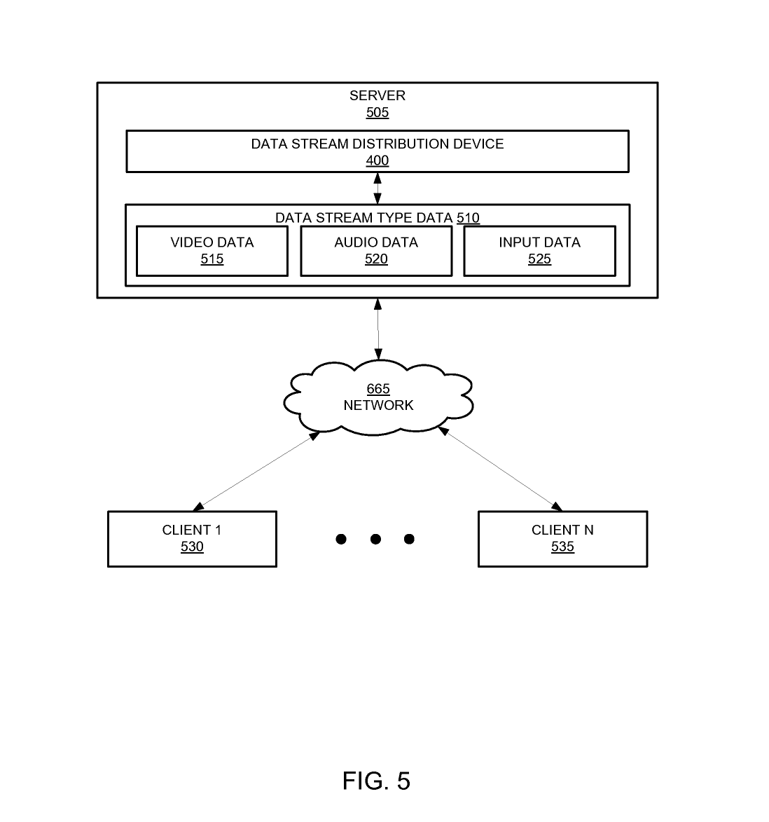

FIG. 5 is block diagram of a one-to-many connection of a server distributing content to a plurality of clients corresponding to a plurality of devices, according to embodiments of the invention. The server 505 in FIG. 5 may be the same as or similar to servers 340 and 345 in FIG. 3. For example, the server 505 may be a locally-based server connected via network 665 to the plurality of clients. In one or more embodiments of the invention, the server 505 may include the data distribution device's 400 capabilities of rendering, processing, and displaying content for the plurality of clients. In one or more embodiments of the invention, the server 505 may further include data stream type data 510 stored as different data stream types (e.g., video, audio, etc.). In one or more embodiments, a cloud server may stream the data stream type data 510 using the data stream distribution device 400. The data stream type data 510 may include, but is not limited to, video data 515, audio data 520, input data 525, and any other types of data capable of generation and storage on the server 505.

In one or more embodiments, the video data 515 includes video content to distribute to a client for display. The video data 515 may be stored in any format (e.g., NTSC, PAL, etc.). In one or more embodiments, the audio data 520 includes audio content to distribute to a client. Similarly, the audio data 520 may be stored in any format. In one or more embodiments, the input data 525 may include a library of input commands stored in any format. Additional data may be included in the data stream type data 510 and the data stream types shown should not limit the scope of the invention.

As described above, data stream distribution device 400 may be configured to distribute data stream type data 510 to the plurality of clients, for example, the distribution of multiplayer gaming content. The plurality of clients may include a first client 530 and a second client 535. In one or more embodiments, the first client 530 and the second client 535 may be gaming devices. Further, the plurality of clients may further include any number of clients. In other words, the first client 530 and the second client 535 may be accompanied by any number of clients. In addition, the data stream distribution device 400 may be configured to receive data stream type data 510 plurality of clients 530 and 535 via a communication link over network 665. In one or more embodiments, the network 665 between the plurality of clients 530 and 535 and data stream distribution device 400 may be a wired or wireless network employing any standard including, but not limited to, Wi-Fi, Bluetooth, etc.

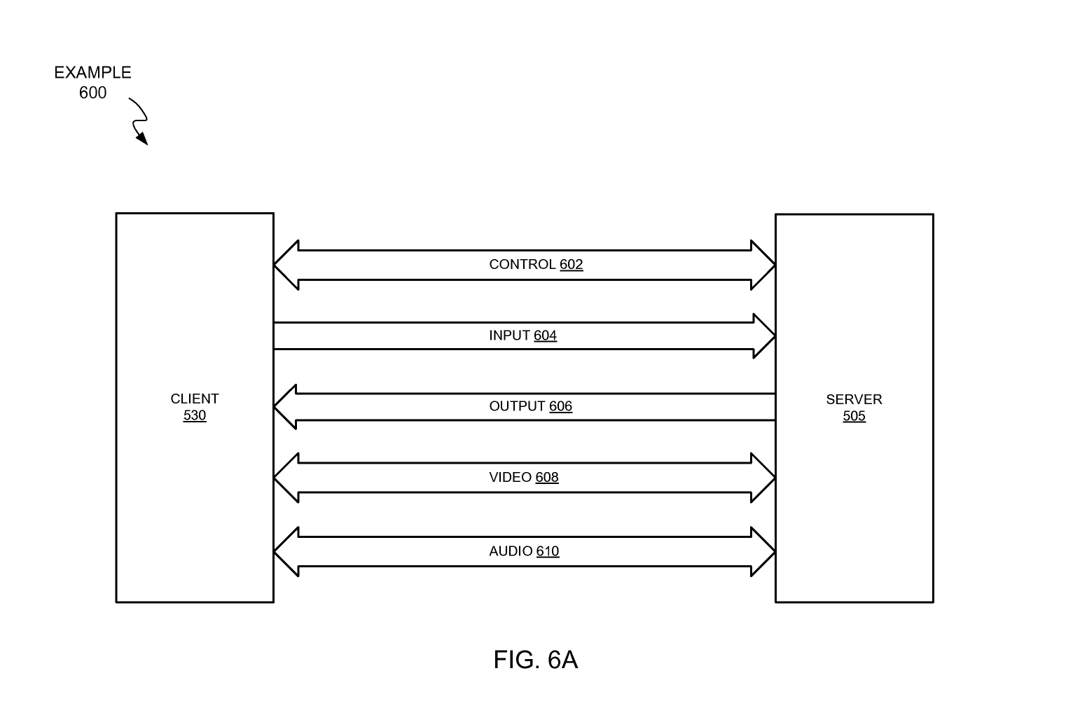

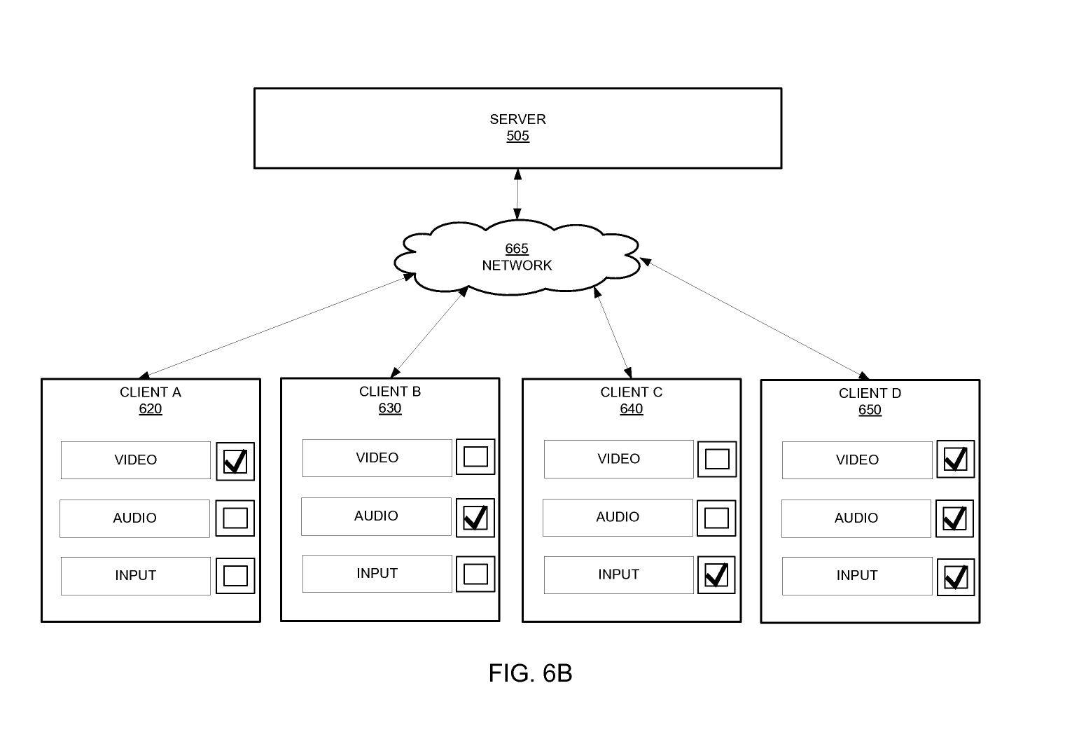

FIG. 6A shows an example 600 of a server and a client communicating different data stream types, according to embodiments of the present invention. In one or more embodiments, the server 505 performs processing and rendering of the content, while client 530 performs video display, audio playback, gathering of user input, etc. The data stream type data shown in FIG. 6A is an example and should not limit the scope of the invention. The directional arrows depicted in FIG. 6A shows examples of different types of data stream type data streaming in different directions between the server 505 and the client 530. In one or more embodiments, control 602 data may stream bi-directionally between the server 505 and the client 530.

In one or more embodiments, input 604 data may stream from the client 530 to the server 505. For example, the client may stream input commands from a gaming controller (or any other input device) connected to a server via Bluetooth (or any other communication standard). In one or more embodiments, output 606 data may stream from the server 505 to the client 530. For example, the server may send output commands instructing the wireless game controller to vibrate corresponding to an input command sent by the client to the server. In one or more embodiments, video 608 data and audio 610 data may stream bi-directionally between the server 505 and the client 530. For example, the server may stream video data for a multiplayer game to a display screen and simultaneously stream audio data for the multiplayer game to a wireless headset.

FIG. 6B shows an example of a server providing different data stream types to a plurality of clients, according to embodiments of the present invention. As shown in FIG. 6B, a server 505 is connected via network 665 to a plurality of clients similar to FIG. 5. As depicted, the server 505 streams to four clients: Client A 620, Client B 630, Client C 640, and Client D 650.

In FIG. 6B, Client A 620 may send a client request to the server 505 via network 665 for video data. The client request may be sent using a communication interface component 125 or may directly connect to server via network using a wireless adapter. The server 505 processes and renders data based on the client request sent by each client. Accordingly, the streaming module 458 streams the requested data to the client. In one or more embodiments, Client A 620 may be a television operable of displaying the video data on its display device.

As shown in FIG. 6B, Client B 630 may send a client request to the server 505 via network 665 for audio data. In one or more embodiments, the server 505 may synchronize the audio data with the video data provided to Client A 620 using the synchronizing module 546. In other embodiments, the audio data may be stored by the server 505 and streamed to Client B 630 as an audio playback. For example, the audio playback may be an audio recording of a previous session of a multiplayer game.

Still referring to FIG. 6B, Client C 640 may send a client request for sending input data to the server 505 via network 665. The server 505 establishes a session of the data stream type based on the client request. In one or more embodiments, the input data stored in the server 505 may include a data stream type data 510 correlating to instructions for rendering and processing graphics for display and audio for playback. For example, Client C 640 may be a wireless game controller sending input commands to the server 505 that map to commands stored as data stream type data 510 and generate a visual and/or audio response, for example, on separate devices connected to the network 665. In one or more embodiments, the input commands are gathered from Client C 640 by the server 505 using the decoding module to decode the encoded input commands into recognizable input data. The server 505 may then display the processing and rendering of video, audio, and any other data stream types correlated to that input data.

In one or more embodiments, the server 505 may send output data to Client C 640. In one or more embodiments, the server 505 may send output data to Client C 640 in response to the input data received by the server 505. The output data may be sent to Client C 640 including instructions to perform functions on the computing device of Client C 640. For example, the data distribution device 400 may send output data including instructions to vibrate a gaming controller in response to input commands sent to the server 505 by the gaming controller.

As further depicted in FIG. 6B, Client D 650 sends a client request to the server 505 via network 665 requesting video, audio, and input data. In one or more embodiments, multiple data stream types may be distributed to one client. For example, Client D 650 may be a handheld game device capable of displaying video, playing audio, and sending input commands to the server 505 rather than devices designed for a single data stream type. In one or more embodiments, a client request may include requesting only audio and video data from the server 505. For example, a gaming device may only receive a spectator view of a multiplayer session in progress. The spectator view may include rendering and processing graphics and playing audio. Further, the inactive player may observe the active players in the multiplayer session as a spectator. The active player includes a player capable of sending input data to affect the course of the game. In other embodiments, a spectator may include input commands to render and process the graphics and play audio. For example, the spectator may use a gaming controller to move throughout a multiplayer game as an inactive player without affecting active players.

It can be appreciated that while FIG. 6B depicts four clients, any number of clients may be present.

It should be appreciated that the data stream distribution device 400 may distribute video data, audio data, and gather input data for a single game to a plurality of clients corresponding to a plurality of specialized devices without a game console. For example, a wireless game controller, a television coupled with a communication interface component 125 (e.g., a dongle, and headset with Bluetooth) may be connected to a server 505 for retrieving game data stored on a cloud-based server. It should be further appreciated that any number of clients retrieving various data stream types may be connected to the server 505. It should also be appreciated that data stream distribution device 400 may generate spectator player mode during a gaming session using a plurality of devices that includes depicting game play without affecting active players.

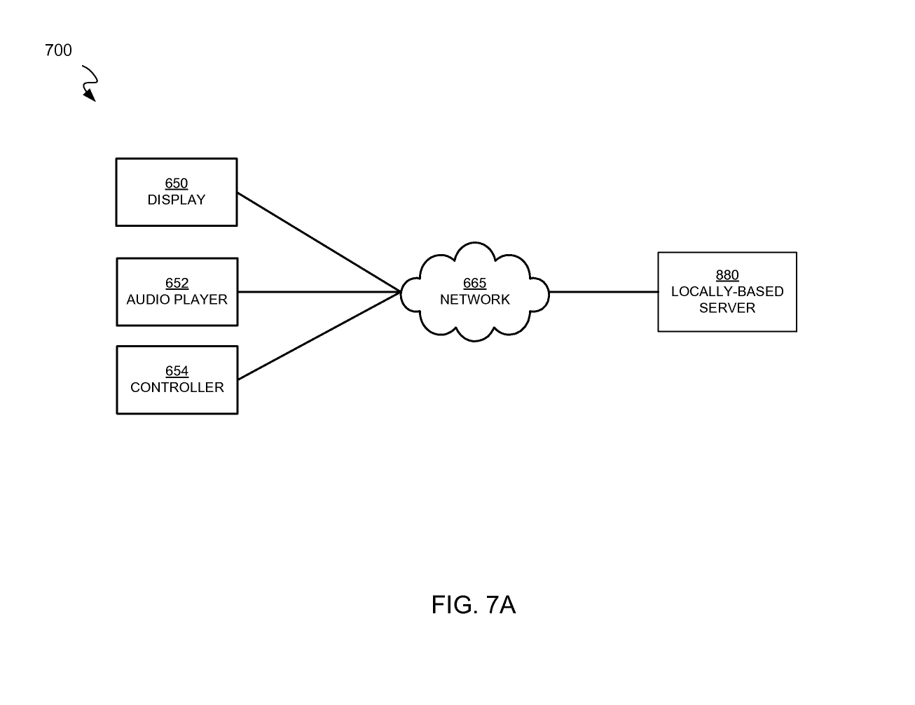

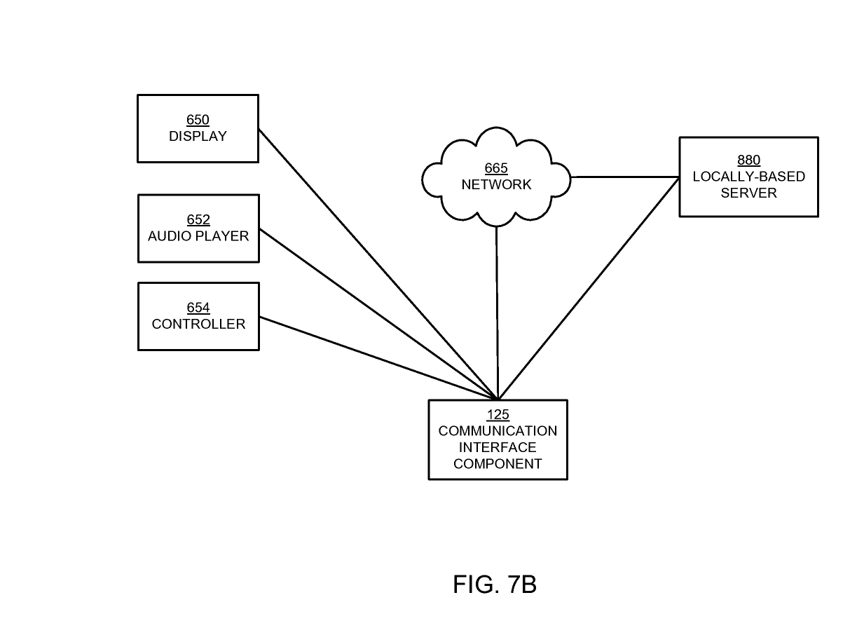

FIG. 7A is a block diagram of a display 650, an audio player 652, and a controller 654 connected to a locally-based server 880 via network 665, according to embodiments of the present invention. The display 650, the audio player 652, and the controller 654 of FIG. 7A may be the same as or similar to devices 530, 535, 620, 630, 640, and 650 of FIGS. 5 through 6B. In addition, the locally-based server 880 may be the same as or similar to the server 505 of FIGS. 5 through 6B.

The display 650, the audio player 652, and the controller 654 may be communicatively coupled with a locally-based server 880 through a network 665, for example, through wired or wireless interfaces. The network 665 may be similar to the network 350 of FIG. 3 and may include local area network (LAN) portions.

The locally-based server 880 may be a computer system that is located proximately to the display 650, the audio player 652, and the controller 654. For example, the locally-based server 880 may be located in the same house or building as the display 650, the audio player 652, and the controller 654, or connected with the display 650, the audio player 652, and the controller 654 primarily through a LAN. In other words, the locally-based server 880 could be a household personal desktop computer.

In one example, the locally-based server 880 may execute a software application requiring graphics and audio processing. The locally-based server 880 may then transmit the graphics and audio to the display 650 and the audio player 652, as well as receive input from the controller 654.

The locally-based server 880 may still provide generated data related to an application to the display 650, the audio player 652, and the controller 654. Alternatively, the locally-based server 880 may play back media that requires stronger processing than the display 650, the audio player 652, and the controller 654 is able to provide. For example, the locally-based server 880 may decode a high-resolution high-fidelity movie that is unable to be processed by the display 650 and the audio player 652 by themselves, and then send appropriately downscaled video and down-sampled audio related to the movie to the display 650 and the audio player 652.

The display 650, the audio player 652, and the controller 654 may be operable to send user inputs to the locally-based server 880. For example, the display 650, the audio player 652, and the controller 654 may send data representing user interaction with the physical controls (e.g. buttons, volume dial, etc.), touchscreen, internal/external motion tracking components, and so on, to the locally-based server 880. In this way, a user may control software applications or content that is being executed on the locally-based server 880. The display 650, the audio player 652, and the controller 654 may send user inputs through the network 665.

The display 650 may be any display, for example, a large display like a flat panel HDTV. The audio player 652 may be any audio player, for example, a wireless speaker system. Further, the controller may be any controller, for example, a generic wireless game controller. The locally-based server 880 may transmit images, video, audio, and other data to the display 650, the audio player 652, and the controller 654 through the network 665. The display 650 may then be able to display the video, the audio player 652 may be able to play back the audio, and the controller 654 may be able to react on force-feedback data. Further, the display 650, the audio player 652, and the controller 654 may make use of the transmitted data. For example, the data may include instructions to the display 650 and the audio player 652 to change to different audio or video modes.

In various embodiments, the locally-based server 880 may execute a video game using components discussed above with reference to FIGS. 1 through 6B, like a processor, graphics processing system, memory, and so on. The locally-based server 880 may send video and audio related to the video game to the display 650 and the audio player 652 which in turn may display and play the content. As a result, the display 650 may show the output of a video game played and the audio player 652 may play the sound of the video game using the locally-based server 880. The server 880 may receive input from the controller 654.

It should be appreciated that there may be more than one display, audio player, and controller connected with the locally-based server 880. It should be appreciated that embodiments discussed below with respect to the following figures may also include multiple clients in the same way. For example, a second display may show a spectator view rather than an active player view shown by a first display.

The video, audio, and/or other data transmitted from the locally-based server to the display 650, the audio player 652, and the controller 654 may or may not be compressed before sending, and decompressed and/or decoded when received by the display 650, the audio player 652, and the controller 654. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the locally-based server 880 may compress the data into H.264 format for transmittal to the display 650, the audio player 652, and the controller 654. Once the display 650, the audio player 652, and the controller 654 receive the data, it may decompress and display the video, audio, and/or other data. It should be noted that in all embodiments of the invention, the file formats used are not limited to H.264 and that the communication protocols may be but are not limited to IEEE 802.11 protocols, but for example, may include Bluetooth.

It should be noted that a communication interface component 125, as discussed with respect to FIG. 7B below, may be coupled with the display 650, the audio player 652, and the controller 654. As a result, even though the server may communicate with the display 650, the audio player 652, and the controller 654 through the network 665, the display 650, the audio player 652, and the controller 654 may be coupled with the network 665 through the communication interface component 125. In other words, the communication interface component 125 may be operable to allow the display 650, the audio player 652, and the controller 654 to communicate through the network 665.

FIG. 7B is a block diagram of a display 650, an audio player 652, and a controller 654 communicatively coupled with a locally-based server 880, according to embodiments of the present invention. FIG. 7B includes a communication interface component 125 that is operable to allow the locally-based server 880 to communicate with the display 650, the audio player 652, and the controller 654 without a network.

The communication interface component 125 may be, for example, a cable set-top box operable to provide video and audio from the locally-based server 880 to the display 650, the audio player 652, and the controller 654. The communication interface component 125 may be, for example, a dongle with an HDMI port that is operable to connect with the display's 650 HDMI port. It should be appreciated that the interface component 125 may support other interfaces that are operable to provide video, audio, and/or data. For example, a DVI connection. The interface component 125 may also be operable to wirelessly communicate with the locally-based server 880. As a result, the locally-based server 880 may transmit video, audio, and/or data to the interface component 125, which in turn may provide such information to the display 650, the audio player 652, and the controller 654. Ultimately, the video, audio, and/or other data sent by the locally-based server 880 may be displayed or played by the display 650, the audio player 652, and the controller 654 similarly to the embodiments discussed with respect to FIG. 7A.

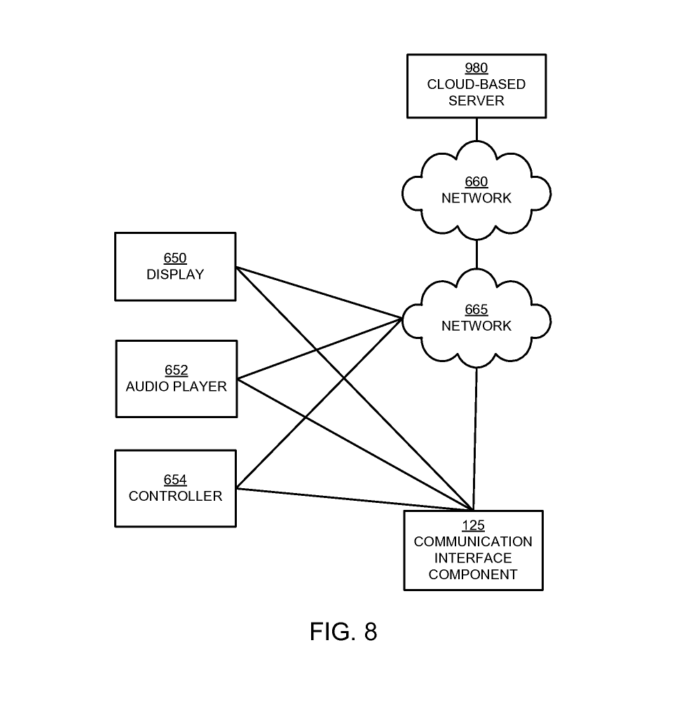

FIG. 8 is a block diagram of a display 650, an audio player 652, and a controller 654 communicatively coupled with a cloud-based server 980, according to embodiments of the present invention. The cloud-based server 980 of FIG. 8 may be the same as or similar to the server 505 of FIGS. 5-7B.

The display 650, the audio player 652, and the controller 654 may be communicatively coupled with the cloud-based server 980 through a network 660 and/or 665, for example, through wired or wireless interfaces. The networks 660 and 665 may be similar to the network 350 of FIG. 3. For example, the network 660 may be wide area network (WAN) while the network 665 is a local area network (LAN).

The cloud-based server 980 may be part of a cloud-based computing system. Cloud computing is the use of computing resources (hardware and software) that are delivered as a service over a network (typically the Internet). Therefore, the cloud-based server 980 may be remotely located from the display 650, the audio player 652, and the controller 654. For example, the cloud-based server 980 may be located in a separate building or city as the display 650, the audio player 652, and the controller 654.

In one example, the cloud-based server 980 may execute a software application requiring graphics and audio processing. The cloud-based server 980 may then transmit the graphics and audio to the display 650, the audio player 652, and the controller 654 for display, play-back, and gathering input.

The video, audio, and/or other data transmitted from the cloud-based server 980 may or may not be compressed before sending, and decompressed and/or decoded when received by the display 650, the audio player 652, and the controller 654. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the cloud-based server 980 may compress the data into H.264 format for transmittal to the display 650, the audio player 652, and the controller 654. Once the display 650, the audio player 652, and/or the controller 654 receives the data, it may decompress, display, play, and/or react to in another way received the video, audio, and/or other data.

The display 650, the audio player 652, and the controller 654 may be operable to send user inputs to the cloud-based server 980. For example, the display 650, the audio player 652, and the controller 654 may send data representing user interaction with the physical controls, touchscreen, internal/external motion tracking components, and so on, to the cloud-based server 980. In this way, a user may control software applications or content that is being executed on the cloud-based server 980. The display 650, the audio player 652, and the controller 654 may send user inputs through the networks 660 and/or 665.

Because the cloud-based server 980 may be remotely communicatively coupled with the display 650, the audio player 652, and the controller 654, and because the server 980 may enact logical coupling between the display 650, the audio player 652, and the controller 654, these devices may be able to receive data from the cloud-based server 980 while at different locations. For example, the display 650, the audio player 652, and the controller 654 may be able to receive data from the cloud-based server 980 while at different homes, outdoors, or even while located in different countries. Accordingly, a user of the display 650, the audio player 652, and the controller 654 may be free to travel between different locations and continue to benefit from the services of the cloud-based server 980.

The cloud-based server 980 may provide video, audio, and other data related to the application to the display 650, the audio player 652, and the controller 654. Alternatively, the cloud-based server 980 may play back media and/or execute games that require stronger processing than the display 650, the audio player 652, and the controller 654 is able to provide. For example, the cloud-based server 980 may decode a high-resolution movie that is unable to be processed by the display 650, the audio player 652, and the controller 654 by itself, and then send video and audio related to the movie to the display 650 and the audio player 652.

FIG. 8 includes the display 650, the audio player 652, and the controller 654 that may be coupled with the cloud-based server 980 through the network 665 or directly through a communication interface component 125. The display 650, the audio player 652, and the controller 654 may continue to display video and play back audio sent by the cloud-based server 980. The cloud-based server 980 may communicate with the display 650, the audio player 652, and the controller 654 through the network 665 or directly through a communication interface component 125.

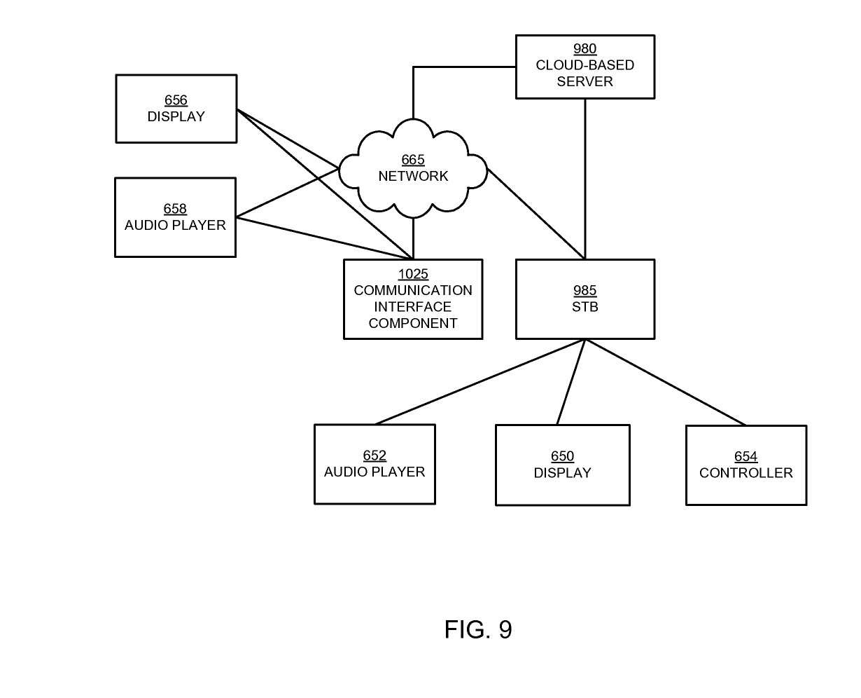

FIG. 9 is a block diagram of a display 650, an audio player 652, and a controller 654 communicatively coupled with the cloud-based server 980 that is in turn communicatively coupled with a set-top box 985, according to embodiments of the present invention. The cloud-based server 980 of FIG. 9 may be the same as or similar to the cloud-based server 980 of FIGS. 5-7B.

Similar to FIG. 8, the display 650, the audio player 652, and the controller 654 may be communicatively coupled with the cloud-based server 980 through a network, for example, through the network 665. As discussed with respect to FIG. 8, the cloud-based server 980 may be part of a cloud-based computing system. Therefore, the cloud-based server 980 may be remotely located from the display 650, the audio player 652, and the controller 654.

FIG. 9 also includes a set-top box (STB) 985 communicatively coupled with the cloud-based server 980. The STB 985 may be a device that may contain a tuner and connects to a television set and an external source of signal, turning the source signal into content in a form that can then be displayed on the television screen or other display device. For example, the STB 985 may be used to provide content from cable or satellite television sources to a television. For example, the STB 985 may be located inside a house or a hotel room and connected to a television, e.g., the display 650.

The STB 985 may receive data from the cloud-based server 980 related to or representing gaming or multimedia content. For example, the cloud-based server 980 may send video, audio, and/or other data through cable or satellite distribution paths to the STB 985. In another example, the cloud-based server 980 may send video, audio, and/or other data through the network 665 to the STB 985 when the STB 985 is coupled with the network 665.

The cloud-based server 980 may send video and audio to the STB 985 through a specific channel that the STB 985 may be operable to tune into. For example, when the STB 985 tunes into channel X, channel X may provide the video and audio representing the content processed by the cloud-based server 980. The STB 985 may send the content to the display 650, the audio player 652, and the controller 654.

In one example, the cloud-based server 980 may execute a software application requiring graphics and audio processing. The cloud-based server 980 may then transmit the graphics and audio to the STB 985 through a certain channel for display and play back ultimately on the display 650, the audio player 652, and the controller 654. Accordingly, the STB 985 may provide the content with the aid of the cloud-based server 980 that the display 650, the audio player 652, and the controller 654 may not have otherwise been able to provide. Even if the display 650, the audio player 652, and the controller 654 may have been able to provide the same content, it may be able to do so at a lower quality or with limitations, but the cloud-based server 980 may be capable of providing higher quality and limitation free content generation.

The display 650, the audio player 652, and the controller 654 may be operable to send user inputs to the cloud-based server 980. For example, the display 650, the audio player 652, and the controller 654 may send data representing user interaction with the physical controls, touchscreen, internal/external motion tracking components, and so on, to the cloud-based server 980. In this way, a user may control software applications or content that is being executed on the cloud-based server 980. The display 650, the audio player 652, and the controller 654 may send user inputs through the network 665. As a result, the video and audio representing the content may be sent through the STB 985 but controlled through the display 650, the audio player 652, and the controller 654.

The cloud-based server 980 may provide generated video and audio related to the application to the STB 985. Alternatively, the cloud-based server 980 may play back media that requires stronger processing than the display 650, the audio player 652, and the controller 654 is able to provide. For example, the cloud-based server 980 may decode a high-resolution movie that is unable to be processed by the display 650, the audio player 652, and the controller 654 by itself, and then send video and audio related to the movie to the STB 985.

FIG. 9 includes a communication interface component 1025 coupled with the cloud-based server 980 and a display 656 and an audio player 658. The display 656 and the audio player 658 may be similar to the display 650 and the audio player 652. The communication interface component 1025 may be similar to the communication interface component 125 of FIG. 7B and may be coupled with the cloud-based server 980 through the network 665. For example, the communication interface component 1025 may be a dongle with an HDMI port (e.g., acting as an HDMI source) that is operable to connect with the display's 656 HDMI port (e.g., acting as an HDMI sink). The communication interface component 1025 may not process the software application or content, but may instead be operable to provide the video and audio processed by the cloud-based server 980 to the display 656 and the audio player 658. In other words, while the communication interface component 1025 may not be a traditional STB, it may provide similar functionality as the STB 985 for channeling content processed and sent from the cloud-based server 980.

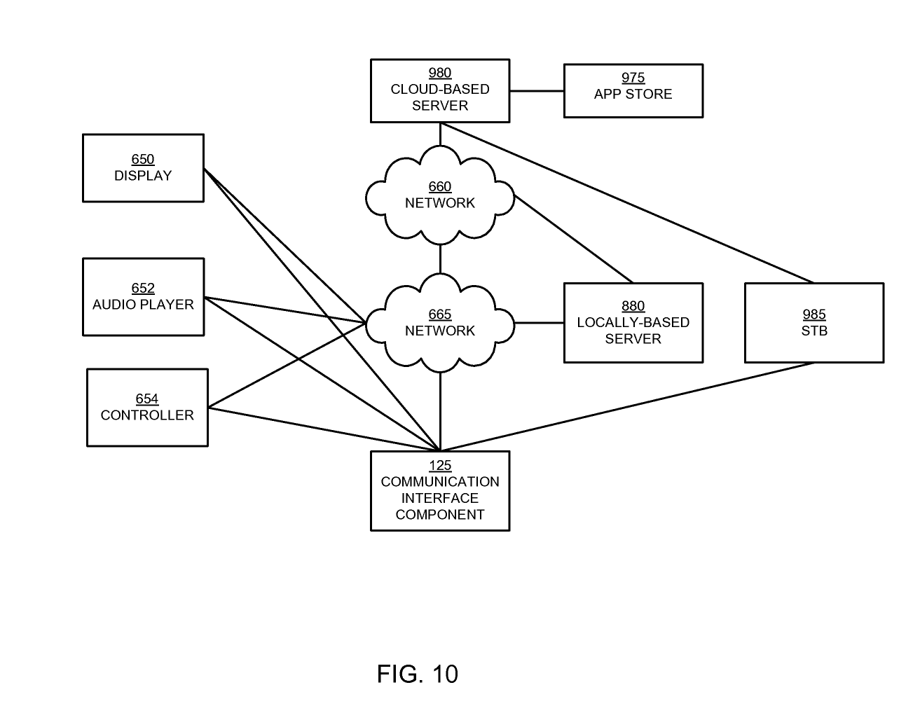

FIG. 10 is a block diagram of a display 650, an audio player 652, and a controller 654 communicatively coupled with an app store 975, locally-based server 880, cloud-based server 980, STB 985, according to embodiments of the present invention. The configuration of FIGS. 7A-8 may include more or less elements or components, for example, a second locally-based server or the absence of the cloud-based server 980. Accordingly, multiple configurations may be possible.

The display 650, the audio player 652, and the controller 654, optionally in conjunction with the locally-based server 880, cloud-based server 980, and/or the display 650, the audio player 652, and the controller 654, may automatically or dynamically determine the configuration of the system. For example, one or more components may determine the configuration of the system and instruct the locally-based server 880 to execute a software application and send the software application content to the display 650, the audio player 652, and the controller 654, e.g., like discussed with relation to FIG. 8. Alternatively, one or more components may determine that and instruct the display 650, the audio player 652, and the controller 654 to execute a game downloaded from the app store 975 onto the server 980.

The determination of the configuration may be based on the software application(s) executed. For example, a software application downloaded from the app store 975 may include with instructions related to the configuration of the software application. In another example, these instructions may be included separately from the software application. Accordingly, the configuration may be dependent on, for example, a specific game or user profile

It should be appreciated that while embodiments of the invention are often discussed with respect to one or more networks, such networks may or may not include devices additional to those shown in the figures. For example, a network may include one or more routers, switches, hubs, and so on. Alternatively, an illustrated network may simply symbolize a communicative coupling between devices. For example, in FIG. 8, the network 665 may symbolize the connection between the display 650, the audio player 652, and the controller 654 and the locally-based server 880. The display 650, the audio player 652, and the controller 654 may be directly connected with the locally-based server 880 through the communication interface of each device, e.g., with or without the use of a wireless router.

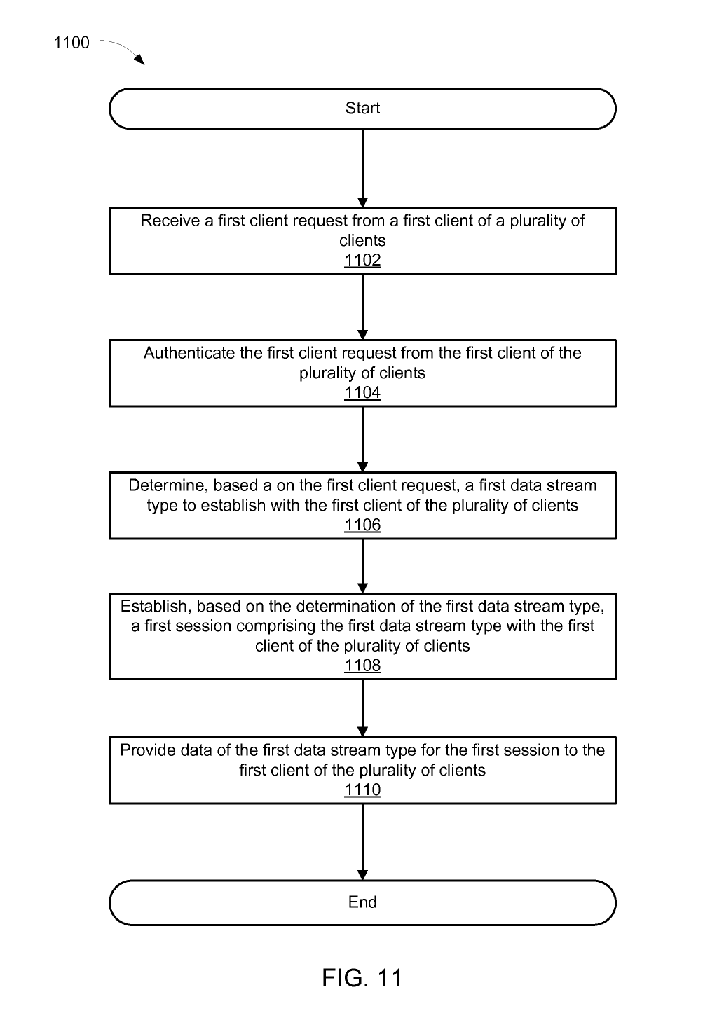

FIG. 11 shows a flowchart 1100 of an exemplary computer-implemented process of distributing data stream type data. While the various steps in this flowchart are presented and described sequentially, one of ordinary skill will appreciate that some or all of the steps can be executed in different orders and some or all of the steps can be executed in parallel. Further, in one or more embodiments of the invention, one or more of the steps described below can be omitted, repeated, and/or performed in a different order. Accordingly, the specific arrangement of steps shown in FIG. 11 should not be construed as limiting the scope of the invention. Rather, it will be apparent to persons skilled in the relevant art(s) from the teachings provided herein, that other functional flows are within the scope and spirit of the present invention. Flowchart 1100 may be described with continued reference to exemplary embodiments described above, though the method is not limited to those embodiments.

In block 1102, a first client request is received from a first client of a plurality of clients. In one or more embodiments, the first client request may include a request for content associated with a multiplayer game. For example, in FIG. 5A, the data stream distribution device distributes, based on the client request, data stream type data to a plurality of clients through the network. The data stream distribution device may receive multiple client requests from the plurality of clients.

In block 1104, the first client request is authenticated from the first client of the plurality of clients. For example, in FIG. 5, the data stream distribution device may receive a client request from the plurality of clients whereby the client request is authenticated by the receiving module verifying the client identifier of client. The client may be authorized using any standard methods to verify the client's compatibility with requested data stream type.

In block 1106, determine, based on the first client request, a first data stream type to establish with the first client of the plurality of clients. For example, in FIG. 4, the receiving module determines a data stream type requested by a client from the plurality of clients. The determination of the client request may be done using decoding module to decode the client request into instructions to provide the requested data stream type or in any manner suitable for identifying the data stream type.

In block 1108, establish, based on the determination of the first data stream type, a first session comprising the first data stream type with the first client of the plurality of clients. For example, in FIG. 6B, the data stream distribution device establishes a session with a client through a network. The first session may be a multiplayer game session of an online multiplayer game.

In block 1110, provide data of the first data stream type for the first session to the first client of the plurality of clients. For example, in FIG. 6B, the data stream distribution device establishes a session including a data stream type streamed to a client using the streaming module. In one or more embodiments, the session may include multiple data stream types streamed by the streaming module depending on the client request.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote gameplay environment, a remote desktop environment, or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A system comprising:
a computer processor; and
a server executing on the computer processor and configured to:
receive a first client request from a first client of a plurality of clients;
authenticate the first client request from the first client of the plurality of clients;
determine, based on the first client request, a first data stream type to establish with the first client of the plurality of clients;
establish, based on a determination of the first data stream type, a first session comprising the first data stream type with the first client of the plurality of clients; and
provide data of the first data stream type for the first session to the first client of the plurality of clients.

2. The system of claim 1, wherein the server executing on the computer processor is further configured to:
receive a second client request from a second client of the plurality of clients;
authenticate the second client request from the second client of the plurality of clients;
determine, based on the second client request, a second data stream type to establish with the second client of the plurality of clients;
establish, based on a determination of the second data stream type, the second session comprising the data stream type for the second client of the plurality of clients; and
provide data of the second stream type for the second session to the second client of the plurality of clients.

3. The system of claim 2, wherein the server executing on the computer processor is further configured to:
synchronize the first session of the first data stream type of the first client with the second session of the second data stream type of the second client.

4. The system of claim 1, wherein the server executing on the computer processor is further configured to:
determine, based on the first client request, a second data stream type to establish with the first client of the plurality of clients; and
provide data of the second data stream type for the first session to the first client of the plurality of clients.

5. The system of claim 1, wherein the plurality of clients comprises a group of computing devices connected to a network and capable of performing at least one action selected from a group consisting of video playback, audio playback, and user input.

6. The system of claim 1, wherein the first client request comprises a vector indicating the first data stream type to establish in the first session of the first client of the plurality of clients.

7. The system of claim 1, wherein:
the first client request comprises a client identifier identifying a computing device of the first client of the plurality of clients; and
the server executing on the computer processor is further configured to determine, based on the client identifier, the first stream type of the first session of the first client of the plurality of clients.

8. A method comprising:
receiving a first client request from a first client of a plurality of clients;
authenticating the first client request from the first client of the plurality of clients;
determining, based on the first client request, a first data stream type to establish with the first client of the plurality of clients;
establishing, based on a determination of the first data stream type, a first session comprising the first data stream type with the first client of the plurality of clients; and
providing data of the first stream type for the first session to the first client of the plurality of clients.

9. The method of claim 8, further comprising:
receiving a second client request from a second client of the plurality of clients;
authenticating the second client request from the second client of the plurality of clients;
determining, based on the second client request, a second data stream type to establish with the second client of the plurality of clients;
establishing, based on a determination of the second data stream type, the second session comprising the data stream type for the second client of the plurality of clients; and
providing data of the second stream type for the second session to the second client of the plurality of clients.

10. The method of claim 9, further comprising:
synchronizing the first session of the first data stream type of the first client with the second session of the second data stream type of the second client.

11. The method of claim 8, further comprising:
determining, based on the first client request, a second data stream type to establish with the first client of the plurality of clients; and
providing data of the second data stream type for the first session to the first client of the plurality of clients.

12. The method of claim 8, wherein the plurality of clients comprises a group of computing devices connected to a network and capable of performing at least one action selected from a group consisting of video display, audio playback, and user input.

13. The method of claim 8, wherein the first client request comprises a vector indicating the first data stream type to establish in the first session of the first client of the plurality of clients.

14. The method of claim 8, wherein the first client request comprises a client identifier identifying a computing device of the first client of the plurality of clients wherein the first client request comprises a client identifier identifying a computing device of the first client of the plurality of clients and determining, based on the client identifier, the first stream type of the first session of the first client of the plurality of clients.

15. A non-transitory computer readable medium comprising a plurality of instructions configured to execute on at least one computer processor to enable the computer processor to:
receive a first client request from a first client of a plurality of clients;
authenticate the first client request from the first client of the plurality of clients;
determine, based on the first client request, a first data stream type to establish with the first client of the plurality of clients;
establish, based on a determination of the first data stream type, the first session comprising the first data type with the first client of the plurality of clients; and
provide data of the first stream data type for the first session to the first client of the plurality of clients.

16. The non-transitory computer readable medium of claim 15, wherein the plurality of instructions further enable the computer processor to:
receive a second client request from a second client of the plurality of clients;
authenticate the second client request from the second client of the plurality of clients;
determine, based on the second client request, a second data stream type to establish with the second client of the plurality of clients;
establish, based on a determination of the second data stream type, the second session comprising the data stream type for the second client of the plurality of clients; and
provide data of the second stream type for the second session to the second client of the plurality of clients.

17. The non-transitory computer readable medium of claim 16, wherein the plurality of instructions further enable the computer processor to:
synchronize the first session of the first data stream type of the first client with the second session of the second data stream type of the second client.

18. The non-transitory computer readable medium of claim 15, wherein the plurality of instructions further enable the computer processor to:
determine, based on the first client request, a second data stream type to establish with the first client of the plurality of clients; and
provide data of the second data stream type for the first session to the first client of the plurality of clients.

19. The non-transitory computer readable medium of claim 17, wherein the plurality of clients comprises a group of computing devices connected to a network and capable of performing at least one action selected from a group consisting of video display, audio playback, and user input.

20. The non-transitory computer readable medium of claim 17, wherein the first client request comprises a vector indicating the first data stream type to establish in the first session of the first client of the plurality of clients.
